(19) United States
(12) Patent Application Publication
(10) Pub. No.: US 2021/0082327 A1
(43) Pub. Date: Mar. 18, 2021

(54) OVERCURRENT PROTECTION CIRCUIT AND METHOD FOR DC-DC CONVERSION CIRCUIT, AND DISPLAY PANEL

(71) Applicant: Shenzhen China Star Optoelectronics Semiconductor Display Technology Co., Ltd., Shenzhen (CN)

(72) Inventor: Xianming Zhang, Shenzhen (CN)

(73) Assignee: Shenzhen China Star Optoelectronics Semiconductor Display Technology Co., Ltd., Shenzhen (CN)

(21) Appl. No.: 16/304,678

(22) PCT Filed: Sep. 20, 2018
(86) PCT No.: PCT/CN2018/106595

§ 371 Date: Nov. 26, 2018

(30) Foreign Application Priority Data
Jul. 10, 2018 (CN) 201810752831.2

(51) Int. Cl. G09G 3/00; H02M 3/158; H02M 1/32

(52) U.S. Cl. CPC G09G 3/006; H02M 3/158; G09G 2330/04; G09G 2330/025; H02M 1/32

(57) ABSTRACT

The invention provides an OCP circuit and method for DC-DC conversion circuit and display panel. The OCP circuit comprises: a first comparator (OP1) for comparing the OCP detection voltage (V1) in the DC-DC conversion circuit and a first reference voltage (Vref1), and outputting a first comparison result (EN1) to logic processor, a second comparator (OP2) for comparing the OCP detection voltage (V1) and a second reference voltage (Vref2), outputting a second comparison result (EN2) to the logic processor; the logic processor, according to the first comparison result (EN1) and the second comparison result (EN2) determining the working state of the DC-DC conversion circuit, and outputting corresponding control signals to the OCP current limiter; the OCP current limiter performing OCP to the DC-DC conversion circuit according to the control signal. The invention also limits the magnitude of the output current after OCP occurs.

### BACKGROUND OF THE INVENTION

### 1. Field of the Invention

The present invention relates to the field of display techniques, and in particular to an overcurrent protection circuit and method for DC-DC conversion circuit and display panel.

### 2. The Related Arts

A power management chip (PM IC) is an IC chip that provides voltage and current in driving a display panel, and the main function is to convert a voltage into various voltages required for a display panel by a direct current-direct current (DC-DC) conversion circuit.

The known overcurrent protection (OCP) methods for the DC-DC converter circuit generally stop the current from increasing after the OCP is triggered, and at the same time, the output voltage is gradually decreased, which causes two consequences; one possible consequence is that the voltage drops a part, but not to trigger the undervoltage protection of the output; and the other is that the output voltage drops too much and triggers undervoltage protection.

In the case of not triggering the undervoltage protection, the entire DC-DC converter circuit operates in a dangerous state due to the output of a large current, and even triggers the risk of smoke and fire.

FIG. 1 shows a schematic view of the structure of a conventional boost circuit. The DC input voltage VIN is processed by a boost circuit composed of an inductor L1, a diode D1, a capacitor C1, and a PWM (pulse width modulation) chip, and is converted into an output voltage Vout. The boosting circuit utilizes the energy storage property of the inductor L1 and the switching transistor Q1 to realize the voltage conversion. When the switching transistor Q1 is closed, the inductor L1 converts the electrical energy into a magnetic field to be stored. When the switching transistor Q1 is cut off, the stored magnetic field energy is converted into an electric field energy by the inductor L1. The energy, after being superimposed with the input voltage VIN, is filtered by the diode D1 and the capacitor C1 to obtain the output voltage Vout. The PWM chip controls the closing and cut-off of the switching transistor Q1, and the magnitude of the output voltage Vout is determined by the duty cycle of the PWM, that is, the switching time of the switching transistor Q1. In the exemplary boost circuit structure, for the PWM chip, a MOS switching transistor Q1 can be built therein, and an OCP current limiter for performing overcurrent protection can be built in, and an OCP current limiter can also be built therein to control the switching transistor Q1. The OCP current limiter can control the output voltage by controlling the switching time of the switching transistor Q1, which in turn controls the output current to achieve overcurrent protection. The OCP detection voltage V1 is taken from the gate of the NMOS switching transistor Q1, and the OCP detection voltage V1 is the detection on the boost circuit structure by the OCP current limiter. The OCP current is generally realized by the detected OCP detection voltage V1. Generally, in the prior art, if the OCP current limiter detects that the OCP detection voltage V1 is greater than a set value, the OCP occurs. The OCP current limiter will limit the output current from increasing.

### SUMMARY OF THE INVENTION

The object of the present invention is to provide an OCP circuit and method for DC-DC conversion circuit and a display panel, to avoid the risk of smoke and fire caused by large output current generated by the known OCP circuit.

To achieve the above object, the present invention provides an OCP circuit for DC-DC conversion circuit, which comprises:

a first comparator, configured to compare an OCP detection voltage in the DC-DC conversion circuit and a first reference voltage, and to output a first comparison result to a logic processor, wherein the first reference voltage being a preset upper limit voltage of the OCP detection voltage during normal operation;

a second comparator, configured to compare the OCP detection voltage and a second reference voltage, to output a second comparison result to the logic processor, wherein the second reference voltage being a preset overcurrent protection trigger voltage, and the second reference voltage being greater than the first reference voltage;

the logic processor, for determining a working state of the DC-DC conversion circuit according to the first comparison result and the second comparison result, and outputting a corresponding control signal to an OCP current limiter;

the OCP current limiter, configured to perform a corresponding overcurrent protection operation on the DC-DC conversion circuit according to the control signal, and when starting to perform the overcurrent protection operation, the OCP detection voltage being limited to be greater than the first reference voltage and smaller than the second reference voltage.

Wherein, the DC-DC conversion circuit is a boost circuit, a buck circuit or a buck-boost circuit.

Wherein, the logic processor determines the working state of the DC-DC conversion circuit in a process, comprising:

if the OCP detection voltage is less than or equal to the first reference voltage, the logic processor determines that the DC-DC conversion circuit works normally, and does not trigger OCP operation;

if the OCP detection voltage is greater than the first reference voltage and less than or equal to the second reference voltage, as long as the OCP detection voltage is not greater than the second reference voltage before, the OCP is not triggered;

if the OCP detection voltage is greater than the second reference voltage, the logic processor determines that the DC-DC conversion circuit is overcurrent, immediately triggers the OCP, and outputs a corresponding control signal to the OCP current limiter.

Wherein, after triggering the OCP, when the OCP detection voltage drops to below the first reference voltage for a period of time, the OCP operation of the OCP current limiter is released.

Wherein, the OCP current limiter limits the OCP detection voltage by pulse width modulation.

Wherein, non-inverting input end of the first comparator inputs the OCP detection voltage, the inverting input end inputs the first reference voltage; the non-inverting input end of the second comparator inputs the OCP detection voltage, and the inverting input end inputs the second reference voltage.

Wherein, the logical processor is a single-chip microcomputer, a CPU, or a field programmable gate array (FPGA).

The present invention also provides a display panel, which comprises any of the above OCP circuits for DC-DC conversion circuit.

The present invention also provides an OCP method for DC-DC conversion circuit, which comprises:

comparing an OCP detection voltage in the DC-DC conversion circuit and a first reference voltage, and outputting a first comparison result, wherein the first reference voltage being a preset upper limit voltage of the OCP detection voltage during normal operation;

comparing the OCP detection voltage and a second reference voltage, and outputting a second comparison result, wherein the second reference voltage being a preset overcurrent protection trigger voltage, and the second reference voltage being greater than the first reference voltage;

determining a working state of the DC-DC conversion circuit according to the first comparison result and the second comparison result, and outputting a corresponding control signal to an OCP current limiter;

an OCP current limiter performing a corresponding overcurrent protection operation on the DC-DC conversion circuit according to the control signal, and when starting to perform the overcurrent protection operation, the OCP detection voltage being limited to be greater than the first reference voltage and smaller than the second reference voltage.

Wherein, a process for determining the working state of the DC-DC conversion circuit comprises:

if the OCP detection voltage is less than or equal to the first reference voltage, a logic processor determines that the DC-DC conversion circuit works normally, and does not trigger OCP operation;

if the OCP detection voltage is greater than the first reference voltage and less than or equal to the second reference voltage, as long as the OCP detection voltage is not greater than the second reference voltage before, the OCP is not triggered;

if the OCP detection voltage is greater than the second reference voltage, the logic processor determines that the DC-DC conversion circuit is overcurrent, immediately triggers the OCP, and outputs a corresponding control signal to the OCP current limiter.

In summary, the OCP circuit and method for DC-DC conversion circuit and display panel of the invention not only realize the original OCP circuit function, and trigger the current of the overcurrent protection, but also at the same time limit the magnitude of the output current after the overcurrent protection occurs to prevent the risk of smoke and fire from high currents, and achieve optimal overcurrent protection.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing the structure of a known boot circuit;

FIG. 2 is a schematic view showing the circuit principle of a preferred embodiment of the OCP circuit for the DC-DC conversion circuit of the present invention.

### DETAILED DESCRIPTION OF THE PREFERRED EMBODIMENTS

To further illustrate the technical means taken by the present invention and resulted effects, the following detailed description is made in conjunction with the preferred embodiments of the present invention and the accompanying drawings.

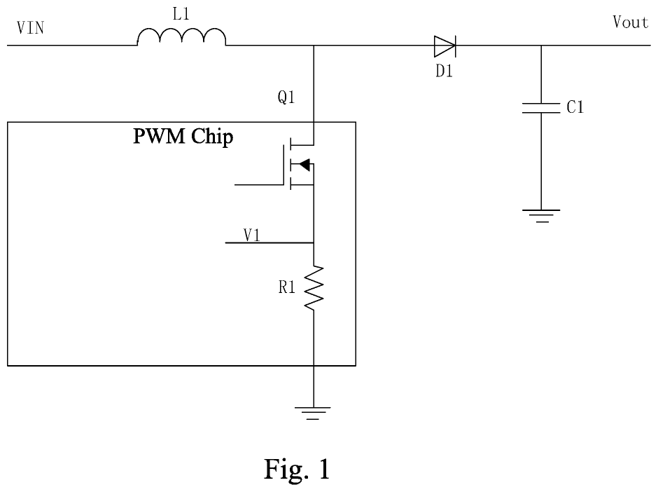

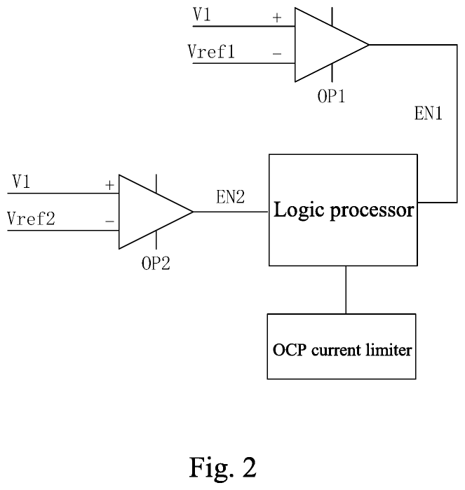

Refer to FIG. 2, which is a schematic view showing the circuit principle of a preferred embodiment of the OCP circuit for the DC-DC conversion circuit of the present invention. The OCP circuit of the present invention can realize, on the basis of the existing OCP circuit, the function of the original OCP circuit and the magnitude of the current of the overcurrent protection. The OCP circuit shown in FIG. 2 can be understood in conjunction with the booster circuit shown in FIG. 1, and other DC-DC conversion circuits can follow the present invention, such as, a buck circuit and a buck-boost circuits, and so on.

The OCP circuit mainly comprises: a first comparator OP1, a second comparator OP2, a logic processor, and an OCP current limiter. In the present embodiment, the non-inverting input end of the first comparator OP1 inputs the OCP detection voltage V1, and the inverting input end inputs a first reference voltage Vref1; the non-inverting input end of the second comparator OP2 inputs the OCP detection voltage V1, and the inverting input end inputs a second reference voltage Vref2. The logical processor can be a single-chip microcomputer, a CPU, or an FPGA.

The first comparator OP1 is configured to compare the OCP detection voltage V1 in the DC-DC conversion circuit and the first reference voltage Vref1, and to output a first comparison result EN1 to the logic processor. The second comparator OP2 is configured to compare the OCP detection voltage V1 and the second reference voltage Vref2, and to output a second comparison result EN2 to the logic processor. The detection of the OCP detection voltage V1 is mainly divided into two parts, one is a preset first reference voltage Vref1, and the value of Vref1 can be about the upper limit voltage of the OCP detection voltage V1 during normal operation, and the second reference voltage Vref2 is a voltage at which the OCP is triggered, and the second reference voltage Vref2 may be consistent with the voltage of the existing triggering voltage of OCP; wherein the second reference voltage Vref2 is greater than the first reference voltage Vref1. According to the input, the first comparison result EN1 and the second comparison result EN2 outputted by the first comparator OP1 and the second comparator OP2 may be 0 or 1.

The logic processor determines a working state of the DC-DC conversion circuit according to the first comparison result EN1 and the second comparison result EN2, and outputs a corresponding control signal to an OCP current limiter. The OCP current limiter is configured to perform a corresponding overcurrent protection operation on the DC-DC conversion circuit according to the control signal, and when starting to perform the overcurrent protection operation, the OCP detection voltage V1 is limited to be slightly greater than the first reference voltage Vref1, such as, within 5% greater than the first reference voltage, and smaller than the second reference voltage Vref2 to prevent large current. The normal operation flow can be described as follows:

If the OCP detection voltage V1 is less than or equal to the first reference voltage Vref1, the logic processor determines that the DC-DC conversion circuit works normally and does not trigger OCP operation.

If the OCP detection voltage V1 is greater than the first reference voltage Vref1 and less than or equal to the second reference voltage Vref1, as long as the OCP detection voltage V1 is not greater than the second reference voltage Vref2 before, the OCP is not triggered. The OCP current limiter and the DC-DC conversion circuit still maintain the original working state; if the previous OCP detection voltage V1 is once greater than the second reference voltage Vref2, the second comparison result EN2 obtained by the logic processor is changed from 1 to 0, which indicates that the OCP of the OCP current limiter has been triggered in the previous period, and the first comparison result EN1 is 1, indicating that the OCP current limiter is still performing OCP without releasing the OCP, the OCP current limiter and the DC-DC converter circuit are in an OCP operating state.

If the OCP detection voltage V1 is greater than the second reference voltage Vref2, the logic processor determines that the DC-DC conversion circuit is overcurrent, immediately triggers the OCP, and outputs a corresponding control signal to the OCP current limiter.

The operation mode of the OCP current limiter is to limit OCP detection voltage V1 to be slightly larger than the first reference voltage Vref1 to limit the current from increasing when OCP is triggered by the second reference voltage Vref2. As such, the long-time extraction of large currents is prevented while the output voltage gradually decreases. After the OCP current limiter starts OCP, if the current limit of the OCP current limiter is to be released, the OCP detection voltage V1 must be lowered to be lower than the first reference voltage Vref1 for a period of time, which can be determined by the logic processor. That is, the corresponding current is decreased for a period of time. At this time, the first comparison result EN1 is changed from 1 to 0, and the logic processor can output a control signal to notify the OCP current limiter to release all current OCP.

In the present embodiment, for the logical processor, only both the first comparison result EN1/the second comparison result EN2 meet the OCP trigger condition to trigger the OCP current limiter to perform OCP; that is, the first comparison result EN1/second comparison result EN2 are both 1. After the OCP is triggered, the OCP detection voltage V1 is set to be slightly larger than the first reference voltage Vref1 by the OCP current limiter. At this time, the second comparison result EN2 is 0, then only after the first comparison result EN1 becoming 0 again, the logical processor can trigger the OCP current limiter to release the OCP state.

The OCP current limiter can be the existing OCP current limiter to influence the OCP detection voltage V1 by PWM. Taking FIG. 1 as an example, the PWM chip can control the output voltage Vout by controlling the switching time of the NMOS switching transistor Q1 so as to control the OCP detection voltage V1. Since the current detection is generally obtained by voltage detection, the OCP current limiter can perform OCP by setting the OCP detection voltage V1 to be slightly larger than the first reference voltage Vref1.

The present invention also provides a display panel, comprising the above OCP circuit for DC-DC conversion circuit.

The present invention also provides an OCP method for DC-DC conversion circuit. The method is performed based on the above OCP circuit or display panel. The method comprises:

comparing an OCP detection voltage V1 in the DC-DC conversion circuit and a first reference voltage Vref1, and outputting a first comparison result EN1, wherein the first reference voltage Vref1 being a preset upper limit voltage of the OCP detection voltage V1 during normal operation;

comparing the OCP detection voltage V1 and a second reference voltage Vref2, and outputting a second comparison result EN2, wherein the second reference voltage Vref2 being a preset overcurrent protection trigger voltage, and the second reference voltage Vref2 being greater than the first reference voltage Vref1;

determining a working state of the DC-DC conversion circuit according to the first comparison result EN1 and the second comparison result EN2, and outputting a corresponding control signal to an OCP current limiter;

an OCP current limiter performing a corresponding overcurrent protection operation on the DC-DC conversion circuit according to the control signal, and when starting to perform the overcurrent protection operation, the OCP detection voltage V1 being limited to be slightly greater than the first reference voltage Vref1.

The present invention improves the OCP method, and uses two determination criteria: one is a reference value for normal operation, that is, a first reference voltage Vref1, and the other is an overcurrent protection value, that is, a second reference voltage Vref2, after triggering OCP, the current is limited to normal operation to prevent long-time extraction of large currents. When lower than the reference value again, the overcurrent protection value can be released again.

In summary, the OCP circuit and method for DC-DC conversion circuit and display panel of the invention not only realize the original OCP circuit function, and trigger the current of the overcurrent protection, but also at the same time limit the magnitude of the output current after the overcurrent protection occurs to prevent the risk of smoke and fire from high currents, and achieve optimal overcurrent protection.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. An overcurrent protection (OCP) circuit for direct current-direct current (DC-DC) conversion circuit, comprising:
a first comparator, configured to compare an OCP detection voltage in the DC-DC conversion circuit and a first reference voltage, and to output a first comparison result to a logic processor, wherein the first reference voltage being a preset upper limit voltage of the OCP detection voltage during normal operation;
a second comparator, configured to compare the OCP detection voltage and a second reference voltage, to output a second comparison result to the logic processor, wherein the second reference voltage being a preset overcurrent protection trigger voltage, and the second reference voltage being greater than the first reference voltage;
the logic processor, for determining a working state of the DC-DC conversion circuit according to the first comparison result and the second comparison result, and outputting a corresponding control signal to an OCP current limiter;
the OCP current limiter, configured to perform a corresponding overcurrent protection operation on the DC-DC conversion circuit according to the control signal, and when starting to perform the overcurrent protection operation, the OCP detection voltage being limited to be greater than the first reference voltage and smaller than the second reference voltage.

2. The OCP circuit for DC-DC conversion circuit as claimed in claim 1, wherein the DC-DC conversion circuit is a boost circuit, a buck circuit or a buck-boost circuit.

3. The OCP circuit for DC-DC conversion circuit as claimed in claim 1, wherein the logic processor determines the working state of the DC-DC conversion circuit in a process, comprising:
if the OCP detection voltage is less than or equal to the first reference voltage, the logic processor determines that the DC-DC conversion circuit works normally, and does not trigger OCP operation;
if the OCP detection voltage is greater than the first reference voltage and less than or equal to the second reference voltage, as long as the OCP detection voltage is not greater than the second reference voltage before, the OCP is not triggered;
if the OCP detection voltage is greater than the second reference voltage, the logic processor determines that the DC-DC conversion circuit is overcurrent, immediately triggers the OCP, and outputs a corresponding control signal to the OCP current limiter.

4. The OCP circuit for DC-DC conversion circuit as claimed in claim 3, wherein after triggering the OCP, when the OCP detection voltage drops to below the first reference voltage for a period of time, the OCP operation of the OCP current limiter is released.

5. The OCP circuit for DC-DC conversion circuit as claimed in claim 3, wherein the OCP current limiter limits the OCP detection voltage by pulse width modulation.

6. The OCP circuit for DC-DC conversion circuit as claimed in claim 1, wherein non-inverting input end of the first comparator inputs the OCP detection voltage, the inverting input end inputs the first reference voltage; the non-inverting input end of the second comparator inputs the OCP detection voltage, and the inverting input end inputs the second reference voltage.

7. The OCP circuit for DC-DC conversion circuit as claimed in claim 1, wherein the logical processor is a single-chip microcomputer, a CPU, or a field programmable gate array (FPGA).

8. A display panel, comprising the OCP circuit for DC-DC conversion circuit as claimed in claim 1.

9. An overcurrent protection (OCP) method for direct current-direct current (DC-DC) conversion circuit, comprising:
comparing an OCP detection voltage in the DC-DC conversion circuit and a first reference voltage, and outputting a first comparison result, wherein the first reference voltage being a preset upper limit voltage of the OCP detection voltage during normal operation;
comparing the OCP detection voltage and a second reference voltage, and outputting a second comparison result, wherein the second reference voltage being a preset overcurrent protection trigger voltage, and the second reference voltage being greater than the first reference voltage;
determining a working state of the DC-DC conversion circuit according to the first comparison result and the second comparison result, and outputting a corresponding control signal to an OCP current limiter;
an OCP current limiter performing a corresponding overcurrent protection operation on the DC-DC conversion circuit according to the control signal, and when starting to perform the overcurrent protection operation, the OCP detection voltage being limited to be greater than the first reference voltage and smaller than the second reference voltage.

10. The OCP method for DC-DC conversion circuit as claimed in claim 9, wherein a process for determining the working state of the DC-DC conversion circuit comprises:
if the OCP detection voltage is less than or equal to the first reference voltage, a logic processor determines that the DC-DC conversion circuit works normally, and does not trigger OCP operation;
if the OCP detection voltage is greater than the first reference voltage and less than or equal to the second reference voltage, as long as the OCP detection voltage is not greater than the second reference voltage before, the OCP is not triggered;
if the OCP detection voltage is greater than the second reference voltage, the logic processor determines that the DC-DC conversion circuit is overcurrent, immediately triggers the OCP, and outputs a corresponding control signal to the OCP current limiter.
